(19) United States
(12) Patent Application Publication
(10) Pub. No.: US 2025/0155874 A1
(43) Pub. Date: May 15, 2025

(54) ELECTRICAL ASSEMBLY AND ASSEMBLY INSTRUCTION INFORMATION FOR THE ELECTRICAL ASSEMBLY

(71) Applicant: G & W Electric Company, Bolingbrook, IL (US)

(72) Inventors: Jason Knott, Plainfield, IL (US); Carlos Zepeda, Bolingbrook, IL (US)

(21) Appl. No.: 18/506,617

(22) Filed: Nov. 10, 2023

(51) Int. Cl. G05B 19/418

(52) U.S. Cl. CPC G05B 19/41805

(57) ABSTRACT

An electrical assembly includes a housing including a panel defining a mounting surface. The housing is structured to receive electrical wiring from an external source. A component is mounted to the mounting surface at a target location on the mounting surface. The component includes at least one of a mounting rail, a wire duct, a terminal block, a circuit interrupter, a switch, an adapter, or a circuit board. Assembly instruction information is displayed on the mounting surface, and the assembly instruction information includes indicia that visually locate the desired location for the component.

### FIELD OF THE DISCLOSURE

The present disclosure relates to electrical equipment and, more specifically, to electrical assemblies having one or more components mounted to a control panel or other type of support surface.

### BACKGROUND OF THE DISCLOSURE

Electrical assemblies, such as those found in electrical control units, cabinets, and other types of enclosures, may include one or more components mounted to a control panel or other type of support surface. Typically, assembly instructions, blueprints, or other informational materials are provided to workers for assembling the electrical equipment (the workers being those who mount the one or more components to the control panel or support surface and/or perform other assembly tasks).

### SUMMARY OF THE DISCLOSURE

A need exists to efficiently provide assembly instruction information to workers tasked with assembling electrical equipment. In some situations, it may be advantageous to provide assembly instruction information directly on a support or mounting surface in addition to, or in place of, providing the assembly instruction information in a separate instruction manual, blueprint, or other document. A worker may find it advantageous and more efficient to be able to reference assembly instruction information applied to or otherwise displayed on the mounting surface where the electrical and related components are to be assembled rather than, or in addition to, referencing a separate assembly instruction document.

As an analogy, it may be easier, faster, and more effective for a painter to create a painting on a medium that includes paint-by-numbers instructions rather than to copy or reproduce the painting from a separate medium, such as a photograph, or separate instruction materials. Stated more generally, providing assembly instructions directly on the working medium to which the electrical and related components are to be mounted may be more efficient than providing the instructions on a separate medium or in another location. Further, it may be advantageous to place assembly instruction information in the form of a label on a mounting surface in an unobtrusive manner prior to assembly such that the label can remain on the mounting surface after assembly, and thereby eliminate the need to remove or discard the instruction documents following assembly. Other features and advantages of the disclosure will become apparent in view of the description and drawings.

In some aspects, the present disclosure provides an electrical assembly including: a housing including a panel defining a mounting surface, the housing configured to receive electrical wiring from an external source; a component mounted to the mounting surface at a desired location thereon, the component selected from a group consisting of: a mounting rail, a wire duct, a terminal block, a circuit interrupter, a switch, an adapter, and a circuit board; and assembly instruction information displayed on the mounting surface. The assembly instruction information includes indicia that visually locate the desired location for the component.

In some aspects, the present disclosure provides a housing for electrical components including: a plurality of surfaces, the plurality of surfaces including a mounting surface on which a plurality of components is mountable; and assembly instruction information displayed on at least a portion of the mounting surface, the assembly instruction information including designated sections that are visually identifiable, each designated section visually indicating one or more of the plurality of components to be mounted to the mounting surface, the one or more of the plurality of components configured to be mounted over the assembly instruction information and within at least one of the designated sections.

In each of the above-described aspects of the present disclosure, the assembly instruction information may be incorporated as an integral part of the mounting surface rather than displayed on a label positioned on the mounting surface. For example, the assembly instruction information may be imprinted, etched, or stamped on the mounting surface.

The present disclosure provides, in yet another aspect, a method of assembling an electrical housing assembly, the method including: displaying assembly instruction information on a mounting surface of the electrical housing to define a desired component layout of the mounting surface, wherein the assembly instruction information designates a type of component to be mounted to the mounting surface at a desired location on the mounting surface; positioning the designated type of component over the assembly instruction information in accordance with the desired component layout; and affixing the designated type of component to the mounting surface over the assembly instruction information in accordance with the desired component layout.

Other aspects of the disclosure will become apparent by consideration of the detailed description and accompanying drawings.

### BRIEF DESCRIPTION OF THE DRAWINGS

FIG. 1 illustrates a perspective view of part of the interior of an exemplary control unit attached to an electrical assembly enclosure.

FIG. 2 illustrates a front view of the interior of the exemplary control unit of FIG. 1 with a door opened.

FIG. 3 illustrates a perspective view of an exemplary interior mounting surface of the control unit of FIG. 2 with an installed assembly instruction label and components mounted thereon.

FIG. 4 illustrates a perspective view of another exemplary interior mounting surface with an installed label and rails mounted thereon.

FIG. 5 illustrates a perspective view of an adapter configured to mount to the rails of FIG. 4 and a circuit board attached to the adapter.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. Also, as used herein and in the appended claims, the terms “upper,” “lower,” “top,” “bottom,” “front,” “back,” and other directional terms are not intended to require any particular orientation but are instead used for purposes of description only.

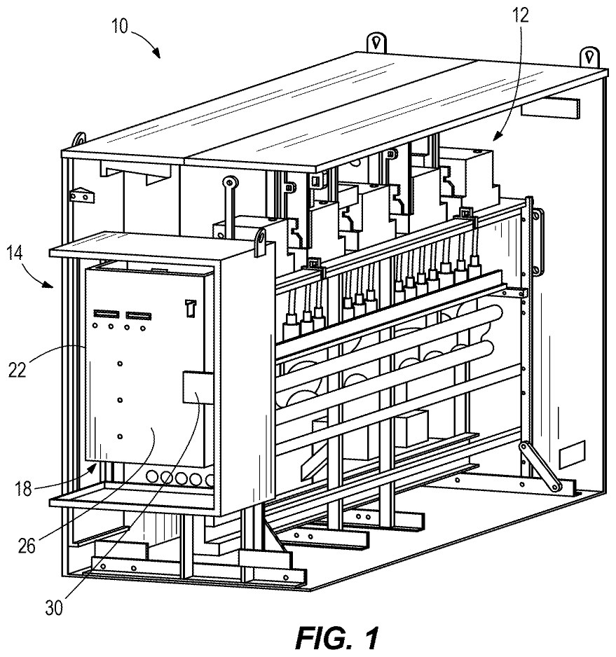

FIG. 1 illustrates an exemplary electrical system enclosure 10 for an electrical system 12, such as a switchgear, a recloser, a breaker panel, a distribution network or system, or another of a wide variety of electrical systems. An exemplary control unit 14 or cabinet is in electrical communication with the electrical system 12 (e.g., through the enclosure 10) to control operation of the electrical system 12 and/or receive data from the electrical system 12. The control unit 14 may be in communication with the electrical system 12 via a hard-wired connection, a wireless connection, or a combination thereof. The illustrated control unit 14 is attached to the electrical assembly enclosure 10, but, in other embodiments, the control unit 14 may be spaced apart from the electrical assembly enclosure 10.

With continued reference to FIG. 1, the illustrated control unit 14 includes an electrical cabinet assembly 18 having a housing 22, which may be referred to as an electrical housing 22. The electrical housing 22 may receive electrical wiring from the electrical system 12 or another external source. A door 26, which may be referred to as a front door, provides access to an interior of the electrical cabinet assembly 18. In the illustrated embodiment, the door 26 is hinged and is positionable in an open position and a closed position. A latch 30 is provided to retain the door 26 in the closed position. In some embodiments, the latch 30 may include a lock to restrict access the interior of the electrical cabinet assembly 18. In some embodiments, the lock may be an interlock coupled to a disconnect switch, such that the door 26 may only be opened when electrical power is disconnected from the electrical system 12 and/or the control unit 14.

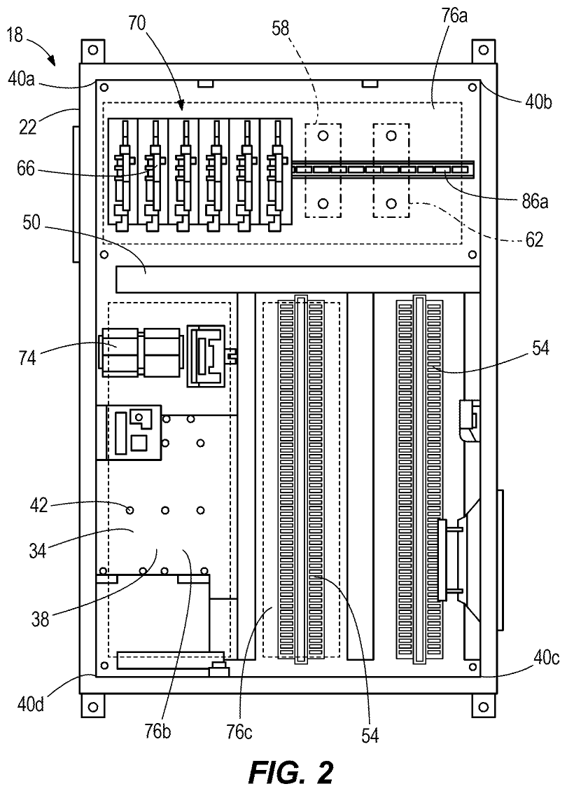

FIG. 2 illustrates an interior of the electrical housing 22 of the electrical cabinet assembly 18 (e.g., with the door 26 open or hidden). The electrical cabinet assembly 18 encloses a control panel 34 that defines a mounting surface 38 located within the electrical housing 22. The electrical housing 22 may include a plurality of interior surfaces (e.g., an interior top surface, an opposite interior bottom surface, an interior right surface, an opposite interior left surface, and an interior back surface extending between the interior top, bottom, left, and right surface), at least one of which may include an interior mounting surface 38. For example, the interior mounting surface 38 may be the interior back surface of the electrical housing 22. The term “interior” mounting surface is merely used for the purpose of description in the context of the illustrated embodiments. In other embodiments, the control panel 34 with the mounting surface 38 may be attached to an exterior surface or otherwise located outside of an electrical housing 22 or other type of electrical enclosure.

The interior mounting surface 38 defines an interior mounting surface plane extending along the interior mounting surface 38. The interior mounting surface 38 may have a plurality of corners and, in the illustrated exemplary embodiment of FIG. 2, includes four corners 40a, 40b, 40c, 40d. The interior mounting surface 38 may also include a plurality of apertures 42 that, in some embodiments, include bores oriented perpendicularly to the plane of the interior mounting surface 38. The apertures 42 may be arranged in a wide variety of patterns on the interior mounting surface 38. In the illustrated embodiment, the apertures 42 are arranged in a grid pattern that is, for example, analogous to the type of grid pattern that may be found on a pegboard. The apertures 42 may be configured to receive fasteners such as screws to fasten one or more components to the interior mounting surface 38.

With continued reference to FIG. 2, a variety of components including, but not limited to, a mounting rail 86a, a wire duct 50, a terminal block 54, a circuit interrupter 58 (e.g., a fuse, a breaker, etc.), a switch 62, a circuit board 66, an adapter 70, and power supply and distribution equipment 74 (such as, for example, a variable frequency drive), may be mounted to the interior mounting surface 38 in a variety of manners, layouts, and orientations and using a variety of means. For example, mounting rails 86a, wire ducts 50, and terminal blocks 54 may be directly fastened to the interior mounting surface 38 by screws or other fasteners. Terminal blocks 54, circuit interrupters 58, and adapters 70 also may be clipped onto or otherwise fastened to mounting rails 86a. Circuit boards 66 and the like may then be fastened to the adapters 70, thereby coupling the circuit boards 66 to the interior mounting surface 38 via mounting rails 86a. In some embodiments, one or more (e.g., all) of the circuit boards 66 and the adapters 70 are pre-assembled prior to installation. Adapters 70 also may be used to fasten a variety of various other components to the mounting rails 86a or directly to the interior mounting surface 38. Wire ducts 50 may be fastened to the interior mounting surface 38 to define electrical wire pathways for electrically connecting components mounted to the interior mounting surface 38 or mounting rails 86a. The circuit interrupter 58 and the switch 62 are represented by the dotted/dashed lines of FIG. 2.

In the illustrated embodiments (see FIG. 2), the interior mounting surface 38 includes designated sections 76a, 76b, 76c that are represented by dashed lines in FIG. 2. The designated sections 76a, 76b, 76c are differentiated based on, for example, the type of component to be mounted in the individual designated sections 76a, 76b, 76c and/or the functional purpose of the designated sections 76a, 76b, 76c. In some embodiments, components such as, for example, mounting rails 86a, wire ducts 50, etc. may at least partially divide the interior mounting surface 38 into the designated sections 76a, 76b, 76c. In the illustrated embodiment, the designated section 76a is an upper section that may include the mounting rail 86a, the circuit interrupter 58, the switch 62, and six circuit boards 66 each mounted on a respective adapter 70. The designated section 76b is a lower left section that may include power supply and distribution equipment 74. Finally, the designated section 76c is a lower middle section that may include a terminal block 54. Of course, in other embodiments, the designated sections 76a, 76b, and 76c may include different components or different numbers of components.

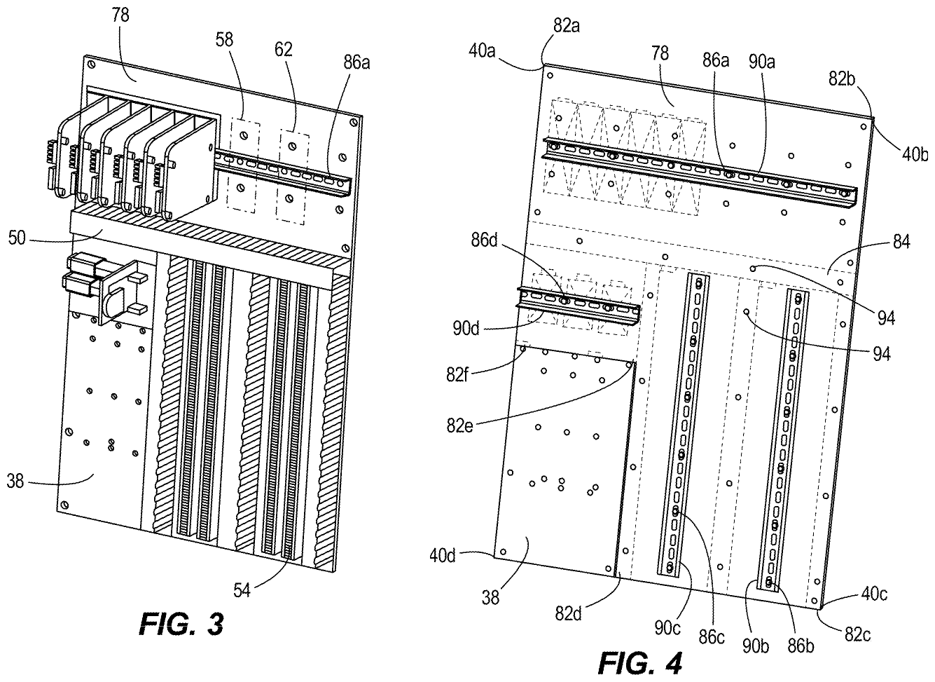

With reference to FIG. 3, an assembly instruction label 78 covers a portion of the interior mounting surface 38. In some embodiments, the label 78 may cover the entirety or substantially all of the interior mounting surface 38. The label 78 illustrated in FIG. 3 defines a label plane when installed on the interior mounting surface 38 that is parallel to the interior mounting surface plane.

With reference to the exemplary embodiment of FIG. 4, label 78 may include a plurality of corners 82a, 82b, 82c, 82d, 82e, 82f. The label 78 may be sized such that at least one, and in some embodiments two or more, of the corners 82a, 82b, 82c, 82d, 82e, 82f is configured to be aligned with one or more of the corners 40a, 40b, 40c, 40d of the interior mounting surface 38 to achieve a desired position and orientation of the label 78 on the interior mounting surface 38.

In the FIG. 4 embodiment, the label 78 was applied to the interior mounting surface 38 prior to installation of the components inside the control unit 14. The mounting rails 86a, 86b, 86c, 86d were installed over the label 78. In this way, other components (e.g., additional mounting rails, the wire duct 50, the terminal block 54, the circuit interrupter 58, the switch 62, the circuit board 66, and/or the adapter 70) are able to also be mounted over the label 78. In other words, the label 78 is applied to the interior mounting surface 38 to designate the desired target locations for subsequently mounting the electrical and related components. Label 78 is secured in place over the interior mounting surface 38. In some embodiments, the label is secured by the mounted components, which clamp label 78 to the interior mounting surface 38.

With continued reference to FIG. 4, each of the components (e.g., the mounting rail 86a, the wire duct 50, the terminal block 54, the circuit interrupter 58, the switch 62, the circuit board 66, and/or the adapter 70) may be mounted to the interior mounting surface 38 at a designated target location. For example, label 78 displays a designated target location 84 (FIG. 4) that corresponds to an underlying target mounting location on interior mounting surface 38 for a wire duct 50, as shown mounted in FIG. 3. Similarly, a first rail 86a may be located at a first target location 90a within a designated section on label 78, a second rail 86b may be located at a second target location 90b within a designated section on label 78, a third rail 86c may be located at a third target location 90c within a designated section on the label 78, and a fourth rail 86d may be located at a fourth target location 90d within a designated section on the label 78.

Label 78 may display a variety of different component information and location indicia (e.g., polygons, arrows, letters, other types of shapes, and/or other indicators) corresponding to the respective components or to show a desired component orientation or layout on the interior mounting surface 38. Such indicia may include a diagram having location markers such as the shape of the subject component to be mounted to the interior mounting surface 38. For example, in some embodiments, a component diagram may correspond to the exact shape of the subject component to be mounted and depict a two-dimensional projection of the component. In other embodiments, instead of an exact shape, the component diagram may be a generic shape symbolizing the shape of the component to be mounted. For example, in some embodiments, the shape may be a rectangle having a length and a width approximately corresponding to an overall length and width of the subject component to be mounted. In other embodiments, the scale of the length and width of the component diagram may be scaled (e.g., 1:2, 1:3, or 1:4, etc.) to the shape of the subject component. In other embodiments, the diagram may not correspond to the shape of the subject component, but may be a circle, an ellipse, a triangle, a parallelogram, an “X”, or another shape symbolizing, but not necessarily corresponding to, the shape of the subject component.

In addition, the label 78 may display instructions on how to install various components to the interior mounting surface 38 or, for example, to a mounting rail 86a. The label 78 may indicate the orientation in which each of the various components is to be mounted to interior mounting surface 38. The assembly instruction information may also include the order of assembly of the components to be mounted to the interior mounting surface 38. For example, each designated section may include a number or a letter corresponding to an order of assembly of the components to be mounted to the interior mounting surface 38. Further, the assembly instructions may describe how to assemble the electrical assembly enclosure 10, the control unit 14, the electrical cabinet assembly 18, the housing 22, and/or other components. Such assembly instructions may include text in addition to or in place of the above-described indicia.

In some embodiments, a location marker may include the name of the component (e.g., “Terminal Block,” “20 A Breaker,” “Fuse,” “Circuit Board,” “Rail,” “Wire Duct,” “Switch,” etc.) written inside or adjacent the designated target location displayed on the label 78. In other embodiments, a symbol may be used that corresponds to a particular component. The label 78 also may include a legend that includes a list of the names of all the components to be mounted within the control unit 14 with corresponding symbols designating each component.

The label 78 may extend beyond a boundary of one or more of the target locations. The label 78 also may be designed and printed such that at least some of the mounted components at least partially cover the assembly instruction information (e.g., the location markers) on the label 78.

With continued reference to FIG. 4, the label 78 may include apertures 94, one or more of which may be configured to receive fasteners and align with one or more of the apertures 42 (FIG. 2) provided in the interior mounting surface 38. In some embodiments, a fastener may be passed through one of the apertures 94 and an aligned aperture 42 to mount a component to the interior mounting surface 38, to fasten the label 78 to the interior mounting surface 38, or both. For example, a first aperture pattern may be configured to align with at least part of the second aperture pattern to define a position and orientation of the label 78 relative to the housing 22, the panel 34, and/or the interior mounting surface 38.

The label 78 may be substantially the same size and shape as the panel 34 and/or the interior mounting surface 38, and in some embodiments, the label 78 may at least partially share a common boundary with the panel 34 and/or the interior mounting surface 38. The desired position and orientation of label 78 on the interior mounting surface 38 may be at least partially defined by an alignment of one or more of the label's apertures 94 with one or more of the mounting surface's apertures 42 and/or, as mentioned above, one or more of the label's corners 82a, 82b, 82c, 82d, 82e, 82f may be aligned with one or more of the mounting surface's corners 40a, 40b, 40c, 40d. In yet other embodiments, other physical or visual features of the label 78 and/or the housing 22 may partially or wholly define a desired position and orientation of the label 78 relative to housing 22 or interior mounting surface 38.

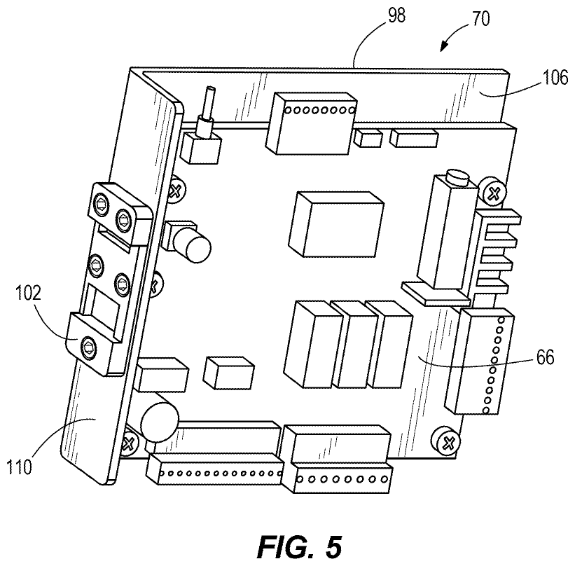

With reference to FIG. 5, an adapter 70 may include an L-shaped plate 98 configured to be coupled to a clip 102 by, for example, a rivet or screw. Alternatively, the plate 98 may be integrally formed with the clip 102. The clip 102 may be configured to be attached to another component such as, for example, one of the rails 86a, 86b, 86c, 86d, for mounting to interior mounting surface 38. In the illustrated embodiment, the plate 98 includes a long face 106 and a short face 110, which are perpendicular or nearly perpendicular to each other. The clip 102 is fastened to the short face 110, and a circuit board 66 may be fastened to one or both of the long face 106 and the short face 110. When the adapter 70, along with an attached circuit board 66, is mounted to one of the rails 86a, 86b, 86c, 86d, a circuit board plane of the circuit board 66, which may be parallel to a plane of the long face 106, is perpendicular to the interior mounting surface plane and to the label plane.

With reference to FIGS. 3 and 4, a method of assembling electrical cabinet assembly 18 may include a first step of placing an assembly instruction label 78 over an interior mounting surface 38 of a housing 22 to define a desired component layout on the interior mounting surface 38. The assembly instruction label 78 displays the desired target locations—that is, the layout—on the interior mounting surface 38 for mounting particular types of components (e.g., one or more of the mounting rails 86a, 86b, 86c, 86d, wire duct 50, the terminal block 54, the circuit interrupter 58, the switch 62, the circuit board 66, and/or the adapter 70). The method further includes the step of arranging the component(s) on the assembly instruction label 78 in accordance with the displayed desired target locations of the interior mounting surface's component layout. The next, and possibly final, step includes affixing the component to the interior mounting surface 38 or to another component to be affixed to the mounting surface to clamp the assembly instruction label 78 between the component and the interior mounting surface 38.

In some embodiments, the label 78 may be affixed to the interior mounting surface 38 by means of an adhesive. In other embodiments, and as disclosed otherwise herein, the label 78 may be affixed to the interior mounting surface by clamping the label 78 between one or more components and the interior mounting surface 38 with or without an adhesive and with or without additional fasteners.

In addition to use in the electrical assembly enclosure 10 and in the control unit 14, the label 78 may be used in a wide variety of other electrical assemblies and enclosures, such as in a metering cabinet for an electrical network or distribution system. The label 78 may be made of plastic having a thickness of, for example, between 5 mil and 100 mil, between 10 and 80 mil, between 20 and 40 mil, or about 30 mil. In some embodiments, the label 78 may be made of a variety of other materials having a variety of thicknesses. In some embodiments, the assembly instruction information may be directly pressed, stamped, painted, imprinted, etched (e.g., laser etched), or otherwise directly incorporated on the interior mounting surface 38 such that the information is an integral part of the interior mounting surface 38.

Various features and advantages of the disclosure are set forth in the following claims.

What is claimed is:

1. An electrical assembly comprising:
a housing including a panel defining a mounting surface, the housing configured to receive electrical wiring from an external source;
a component mounted to the mounting surface at a desired location thereon, the component selected from a group consisting of: a mounting rail, a wire duct, a terminal block, a circuit interrupter, a switch, an adapter, and a circuit board; and
assembly instruction information displayed on the mounting surface, wherein the assembly instruction information includes indicia that visually locate the desired location for the component.

2. The electrical assembly of claim 1, wherein the assembly instruction information includes text.

3. The electrical assembly of claim 1, wherein the assembly instruction information is displayed on a label positioned between the component and the mounting surface such that the component secures at least part of the label in place over the mounting surface.

4. The electrical assembly of claim 3, wherein the label is clamped between the component and the mounting surface.

5. The electrical assembly of claim 1, wherein the indicia show a shape of the component.

6. The electrical assembly of claim 5, wherein the shape is a rectangle having a length and a width corresponding to an overall length and width of the component.

7. The electrical assembly of claim 5, wherein the indicia include a name of the component written inside or adjacent the shape.

8. The electrical assembly of claim 5, wherein the shape indicates the desired location.

9. The electrical assembly of claim 1, wherein the component at least partially divides the mounting surface into a plurality of sections, and wherein the assembly instruction information extends across the plurality of sections.

10. The electrical assembly of claim 1, wherein the panel includes a first aperture pattern to receive fasteners, and wherein the indicia are displayed on a label that includes a second aperture pattern to receive the fasteners, the second aperture pattern configured to align with at least part of the first aperture pattern to define a position and orientation of the label relative to the panel and to locate the desired location.

11. The electrical assembly of claim 1, wherein the mounting surface is an interior surface of the housing.

12. The electrical assembly of claim 1, wherein the assembly instruction information is displayed on a label positioned on the mounting surface.

13. The electrical assembly of claim 1, wherein the indicia include location markers corresponding to each respective component selected to be mounted to the mounting surface, wherein the location markers indicate the desired location for mounting each selected component, and wherein each selected component is mountable to the mounting surface over the assembly instruction information.

14. The electrical assembly of claim 13, wherein the location markers include shapes of each respective component selected to be mounted to the mounting surface.

15. The electrical assembly of claim 13, wherein after installation of at least one of the components within the electrical housing, the at least one component at least partially covers the assembly instruction information or the location markers.

16. A housing for electrical components comprising:
a plurality of surfaces, the plurality of surfaces including a mounting surface on which a plurality of components is mountable; and
assembly instruction information displayed on at least a portion of the mounting surface, the assembly instruction information including designated sections that are visually identifiable, each designated section visually indicating one or more of the plurality of components to be mounted to the mounting surface, the one or more of the plurality of components configured to be mounted over the assembly instruction information and within at least one of the designated sections.

17. The housing of claim 16, wherein the assembly instruction information is displayed on a label positioned on the mounting surface.

18. A method of assembling an electrical housing assembly, the method comprising:
displaying assembly instruction information on a mounting surface of the electrical housing to define a desired component layout of the mounting surface, wherein the assembly instruction information designates a type of component to be mounted to the mounting surface at a desired location on the mounting surface;
positioning the designated type of component over the assembly instruction information in accordance with the desired component layout; and
affixing the designated type of component to the mounting surface over the assembly instruction information in accordance with the desired component layout.

19. The method of claim 18, wherein displaying the assembly instruction information on the mounting surface further comprises displaying the assembly instruction information on a label and positioning the label on the mounting surface.

20. The method of claim 18, wherein displaying the assembly instruction information on the mounting surface further comprises incorporating the assembly instruction information as an integral part of the mounting surface.
